(19) United States
(12) Patent Application Publication
(10) Pub. No.: US 2024/0177381 A1
(43) Pub. Date: May 30, 2024

(54) PHOTOGRAPHIC SOUVENIR AUGMENTATION

(71) Applicant: Royal Caribbean Cruises Ltd., Miami, FL (US)

(72) Inventors: Joshua T. Nakaya, Biscayne Park, FL (US); Ganna Radzevych, Mercer Island, WA (US)

(73) Assignee: Royal Caribbean Cruises Ltd., Miami, FL (US)

(21) Appl. No.: 18/070,641

(22) Filed: Nov. 29, 2022

(51) Int. Cl. G06T 11/60; G06T 11/20

(52) U.S. Cl. CPC G06T 11/60; G06T 11/203; G06T 2210/44

(57) ABSTRACT

Photographic souvenir augmentation includes capturing a digital image of a guest at a location in an attraction and invisibly grid-striping of a portion of the guest based upon a two-dimensional grid. The augmentation additionally includes image sensing the grid-striped portion of the guest and correlating locations of the two-dimensional grid with locations of the grid-striped portion. The augmentation yet further includes selecting a graphical image and transforming the graphical image according to the correlation into a morphed graphical image. Finally, the augmentation includes superimposing the morphed graphical image onto the digital image of the guest and storing the digital image in association with an identifier for the guest.

### BACKGROUND OF THE INVENTION

### Field of the Invention

The present invention relates to the technical field of augmented reality and more particularly to souvenir photography through augmented reality.

### Description of the Related Art

The amusement park attraction provides the basis for the park guest experience and distinguishes one amusement park from another. From the most simple mechanical ride to the more complex immersive, dynamic audiovisual presentation, the traditional amusement park attraction, taking advantage of the latest in coordinated robotics, laser imagery and audio and pyrotechnics, provides an unforgettable experience, especially for children and young adults. Indeed, for the most successful of park attractions, the average guest will seek to repeatedly experience the attraction to the exclusion of other attractions within the park.

Given the impact that any given amusement park attraction may have upon a park guest, it has become customary to include souvenir photography as a memento to the guest, the souvenir photography capturing moments during the attraction experience by a guest. At a different location in the park, at a subsequent time, the guest may then retrieve the souvenir photograph of the guest experiencing the attraction at a key moment during the attraction. Classic examples include photographing a guest within a cart of a rollercoaster just as the cart peaks before careening down a steep slope.

For many years, augmented reality has proven important to some attractions in which imagery is acquired of a guest while the guest experiences the attraction and then the imagery is augmented to include artificial elements, such as an image of another person, a cartoon character or a ghost. The augmented imagery is then presented at a later moment in the attraction to the guest in order to evoke a surprised reaction by the guest. Again, this augmentation of guest imagery during the course of the attraction has proven important to the success of the attraction.

Even still, the augmentation of guest imagery has been limited heretofore as an image segment separate and apart from the imagery of the guest. Souvenir photography has incorporated augmented guest imagery, but only in an non-integrated way. That is to say, conventional guest imagery augmentation for an amusement park attraction can only add secondary fictitious material to the composite imagery alongside imagery of the guest without integrating the secondary fictitious material with the imagery of the guest him or herself.

### BRIEF SUMMARY OF THE INVENTION

Embodiments of the present invention address technical deficiencies of the art in respect to souvenir photography. To that end, embodiments of the present invention provide for a novel and non-obvious method for photographic souvenir augmentation. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a photographic souvenir augmentation method includes the capturing of a digital image of a guest at a location in an attraction and the invisible grid-striping of a portion of the guest based upon a two-dimensional grid. The method additionally includes image sensing the grid-striped portion of the guest and correlating locations of the two-dimensional grid with locations of the striped portion. The method yet further includes selecting a graphical image and transforming the graphical image according to the correlation into a morphed graphical image. Finally, the method includes superimposing the morphed graphical image onto the digital image of the guest and storing the digital image in association with an identifier for the guest.

In one aspect of the embodiment, the grid-striping is drawn across contours of the portion of the guest by transmitted infrared light of an infrared light grid-stripe projector, an infrared light camera sensing the invisible grid pattern. To that end the correlation can include the creation of a table correlating different x-y coordinates of the two-dimensional grid emitted by the infrared light grid-stripe projector with corresponding x-y coordinates in the grid-striping sensed by the infrared light camera and the generation of the morphed image as a collection only of the corresponding x-y coordinates of the two-dimensional grid correlated to the different x-y coordinates of the grid-striping.

Finally, in another aspect of the embodiment, the portion of the guest is an arm of the guest and the graphical image is a tattoo.

In another embodiment of the invention, a data processing system is adapted for photographic souvenir augmentation. The system includes a host computing platform comprising one or more computers, each with memory and one or processing units including one or more processing cores. The system also includes each of a digital camera, an invisible light grid-stripe projector and an invisible light camera. The system yet further includes a photographic souvenir augmentation module. The module includes computer program instructions enabled while executing in the memory of at least one of the processing units of the host computing platform to perform photographic souvenir generation.

In this regard, the photographic souvenir augmentation includes directing the digital camera to capture a digital image of a guest at a location in an attraction and directing the projector to invisibly grid-stripe a portion of the guest based upon a two-dimensional grid, while directing the camera to image sense the grid-striped portion of the guest. The photographic souvenir augmentation additionally includes correlating locations of the two-dimensional grid with locations of the grid-striped portion, selecting a graphical image and transforming the graphical image according to the correlation into a morphed graphical image. Finally, the photographic souvenir augmentation includes superimposing the morphed graphical image onto the digital image of the guest and storing the digital image in association with an identifier for the guest.

In even yet another embodiment of the invention, a computing device is provided with a non-transitory computer readable storage medium having program instructions stored therein. The instructions are executable by at least one processing core of a processing unit so as to cause the processing unit to perform a method for photographic souvenir augmentation. The method includes capturing a digital image of a guest at a location in an attraction, invisibly grid-striping a portion of the guest based upon a two-dimensional grid and image sensing the grid-striped portion of the guest. The method further includes correlating locations of the two-dimensional grid with locations of the grid-striped portion, selecting a graphical image and transforming the graphical image according to the correlation into a morphed graphical image. Finally, the method includes superimposing the morphed graphical image onto the digital image of the guest and storing the digital image in association with an identifier for the guest.

In this way, the technical deficiencies of the souvenir photograph generation process are overcome owing to the creation of an image of a guest with a graphic confirming to the contours of a portion of the body of the guest so as to render an augmented reality image of the guest in an integrated manner.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of photographic souvenir augmentation;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for photographic souvenir augmentation. In accordance with an embodiment of the invention, an image is acquired of a guest within a confined space of an attraction. A target portion of the guest, such as a torso, forearm or leg is located within the image and invisible light grid-striping projected upon the target portion of the guest based upon a two-dimensional grid with corresponding coordinates. An invisible light camera then senses the target portion of the guest and locations of the sensed target portion of the guest are correlated to respective coordinates of the two-dimensional grid in a mapping. A graphical image adapted to the two-dimensional grid is then morphed according to the mapping and superimposed upon the image of the guest at the target portion in order to produce an augmented reality souvenir photograph of the guest.

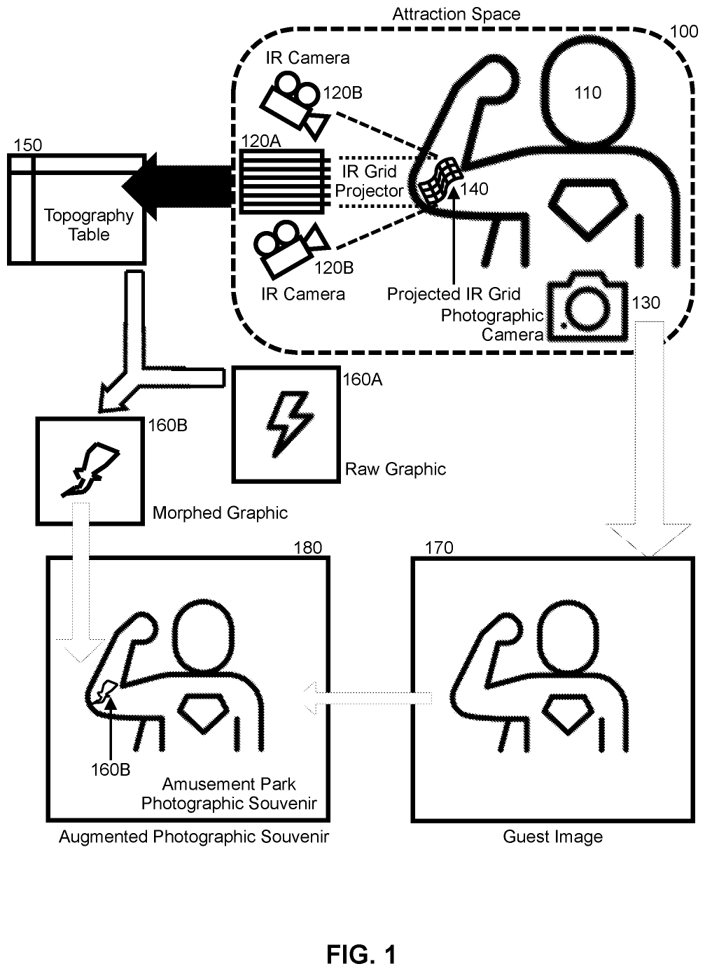

In illustration of one aspect of the embodiment, FIG. 1 pictorially shows a process of photographic souvenir augmentation. As shown in FIG. 1, camera 130 images a guest 110 within an attraction space 100 to produce a guest image 170, and a target portion of the guest 110 is then located in the image 170, such as a forearm, torso or leg. An invisible light grid-stripe projectors 120A such as an IR grid-stripe projector projects grid-striping 140 in accordance with a two-dimensional grid onto the target portion of the guest 110 and one or more invisible light cameras 120B, such as an IR camera, sense the projected grid-striping 140. Different locations of the projected grid-striping 140 are then correlated to corresponding coordinates of the two-dimensional grid in a table 150.

A raw graphic 160A, is then selected, for instance a cartoon image, line art or iconography. The raw graphic 160A is adapted to the two-dimensional grid and then morphed into a morphed graphic 160B in accordance with the table 150. In this regard, a location of each pixel in the two-dimensional grid is transformed to a correlated location set forth in the table 150 and drawn in the morphed image 160B. Likewise, pixels in the two-dimensional grid lacking a correlated location (thus being obscured from view) are omitted from the morphed image 160B. The resulting morphed image 160B is superimposed upon the target location of the guest 110 in the guest image 170 in order to produce augmented reality photographic souvenir 180.

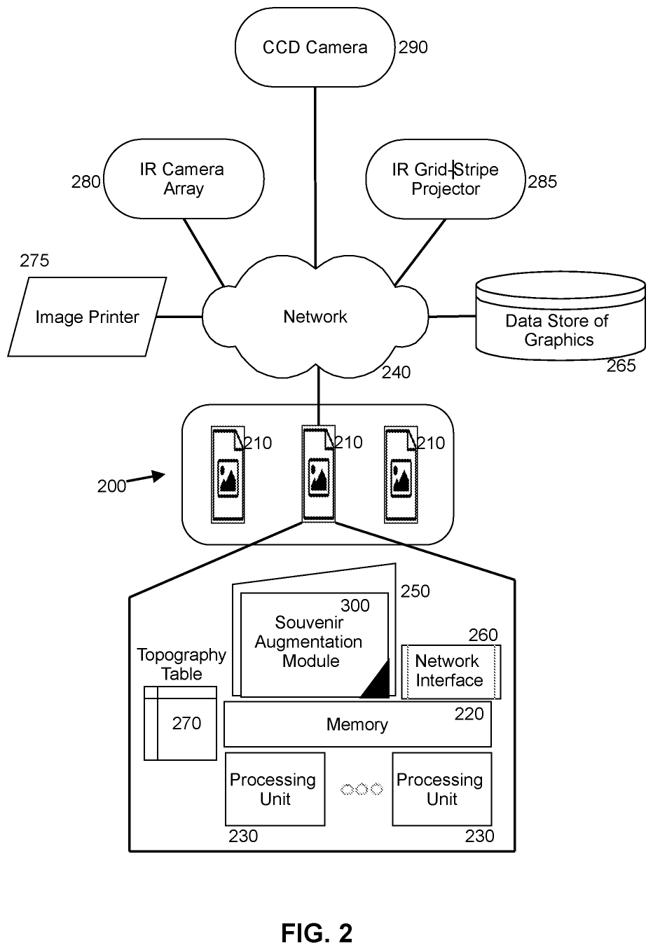

Aspects of the process described in connection with FIG. 1 can be implemented within a data processing system. In further illustration, FIG. 2 schematically shows a data processing system adapted to perform photographic souvenir augmentation. In the data processing system illustrated in FIG. 1, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for photographic souvenir augmentation. Specifically, the program instructions during execution direct a communicatively coupled charge coupled device camera 290 to acquire a digital image of a guest positioned within an area of an attraction. The program instructions then locate in the digital image, a target portion of the guest and direct a communicatively coupled IR grid-stripe projector 285 to project IR grid-striping onto the target portion of the guest according to a pattern defined as a two-dimensional grid. The program instruction thereafter direct a communicatively coupled IR camera array 280 of one or more IR cameras to sense the projected grid-striping.

The program instructions produce a correlation table 270 in the memory 220 of coordinates of the two-dimensional grid to corresponding locations (if present) in the projected grid-striping sensed by the IR camera array. The program instructions then retrieve from a data store of graphics 265, a selected graphic and generate a morphed form of the selected graphic including each pixel in the selected graphic at specific coordinates of the two-dimensional grid transformed to different coordinates based upon a corresponding entry in the table 270, recognizing that some pixels in the selected graphic will not have corresponding coordinates in the table 270 and thus will be omitted in the morphed form of the selected graphic. Finally, the program instructions superimpose the morphed form of the graphic onto the target portion of the guest visible in the acquired digital image in order to produce an augmented photographic image of the guest. The program instructions may then direct a communicatively coupled image printer 275 to print onto a substrate the augmented photographic image.

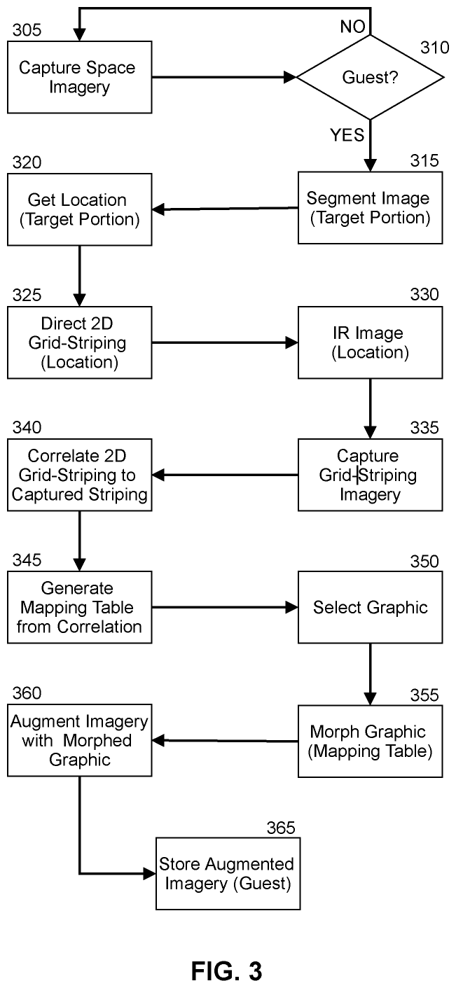

In further illustration of an exemplary operation of the module, FIG. 3 is a flow chart illustrating one of the aspects of the process of FIG. 1. Beginning in block 305, imagery of a space within an attraction can be captured and in decision block 310, it is determined if a guest is present in the space. If so, in block 315, the image is segmented to locate a target portion of the guest, such as a forearm, calf, torso, forehead, hand or any other part of the human form. In block 320, a location on the guest is determined for the target portion and in block 325, an invisible light grid-stripe projector is commanded to project invisible light onto the location of the guest associated with the target portion with a pattern based upon a two-dimensional grid. An invisible light camera is then directed in block 330 to scan the location on the guest in order to capture the projected grid-striping in block 335.

In block 340, each coordinate in the two-dimensional grid is correlated to a corresponding location projected grid-striping in a table with those coordinates lacking a sensed counterpart in the projected grid-striping indicating a lack of correlation so that in block 345, a mapping table is generated with an entry for each coordinate in the two-dimensional grid. In block 350, thereafter, a graphic is selected for use in an augmented reality version of the captured imagery of the guest. Once selected, in block 355 the graphic is morphed into a morphed graphic by mapping each pixel in the selected graphic to a location in the morphed graphic according to the table, with those pixels in the selected graphic lacking a corresponding location in the table being omitted from the morphed graphic. Finally, in block 360 the morphed graphic is superimposed upon the image of the guest at the target portion and in block 365 the resulting augmented souvenir photograph is stored for subsequent retrieval by the guest.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A photographic souvenir augmentation method comprising:
capturing a digital image of a guest at a location in an attraction;
invisibly grid-striping a portion of the guest based upon a two-dimensional grid;
image sensing the grid-striped portion of the guest;
correlating locations of the two-dimensional grid with locations of the grid-striped portion;
selecting a graphical image;
transforming the graphical image according to the correlation into a morphed graphical image;
superimposing the morphed graphical image onto the digital image of the guest; and,
storing the digital image in association with an identifier for the guest.

2. The method of claim 1, wherein the grid-striping is drawn across contours of the portion of the guest by transmitted infrared light of an infrared light grid-stripe projector, an infrared light camera image sensing the grid-striping.

3. The method of claim 2, wherein the correlating comprises:
creating a table correlating different x-y coordinates of the two-dimensional grid emitted by the infrared light stripe projector with corresponding x-y coordinates in the grid-striping sensed by the infrared light camera; and,
generating the morphed image as a collection only of the corresponding x-y coordinates of the two-dimensional grid correlated to the different x-y coordinates of the grid-striping.

4. The method of claim 1, wherein the portion of the portion of the guest is an arm of the guest and wherein the graphical image is a tattoo.

5. A data processing system adapted for photographic souvenir augmentation, the system comprising:
a host computing platform comprising one or more computers, each with memory and one or processing units including one or more processing cores;
a digital photographic camera;
an invisible light grid-stripe projector;
an invisible light camera; and,
a photographic souvenir generation module comprising computer program instructions enabled while executing in the memory of at least one of the processing units of the host computing platform to perform:
directing the digital photographic camera to capture a digital image of a guest at a location in an attraction;
directing the projector to invisibly grid-stripe a portion of the guest based upon a two-dimensional grid;
directing the invisible light camera to image sense the grid-striped portion of the guest;
correlating locations of the two-dimensional grid with locations of the striped portion;
selecting a graphical image;
transforming the graphical image according to the correlation into a morphed graphical image;
superimposing the morphed graphical image onto the digital image of the guest; and,
storing the digital image in association with an identifier for the guest.

6. The system of claim 5, wherein the projector is an infrared light grid-stripe projector and the invisible light camera is an infrared light camera.

7. The system of claim 6, wherein the correlating comprises:
creating a table correlating different x-y coordinates of the two-dimensional grid emitted by the infrared light stripe projector with corresponding x-y coordinates in the grid-striping sensed by the infrared light scanner; and,
generating the morphed image as a collection only of the corresponding x-y coordinates of the two-dimensional grid correlated to the different x-y coordinates of the grid-striping;

8. The system of claim 5, wherein the portion of the portion of the guest is an arm of the guest and wherein the graphical image is a tattoo.

9. A computing device comprising a non-transitory computer readable storage medium having program instructions stored therein, the instructions being executable by at least one processing core of a processing unit to cause the processing unit to perform a method for photographic souvenir augmentation, the method including:
capturing a digital image of a guest at a location in an attraction;
invisibly grid-striping a portion of the guest based upon a two-dimensional grid;
image sensing the grid-striped portion of the guest;
correlating locations of the two-dimensional grid with locations of the grid-striped portion;
selecting a graphical image;
transforming the graphical image according to the correlation into a morphed graphical image;
superimposing the morphed graphical image onto the digital image of the guest; and,
storing the digital image in association with an identifier for the guest.

10. The device of claim 9, wherein the grid-striping is drawn across contours of the portion of the guest by transmitted infrared light of an infrared light grid-stripe projector, an infrared light camera image sensing the grid-striping.

11. The device of claim 10, wherein the correlating comprises:
creating a table correlating different x-y coordinates of the two-dimensional grid emitted by the infrared light stripe projector with corresponding x-y coordinates in the grid-striping sensed by the infrared light camera; and,
generating the morphed image as a collection only of the corresponding x-y coordinates of the two-dimensional grid correlated to the different x-y coordinates of the grid-striping.

12. The device of claim 9, wherein the portion of the portion of the guest is an arm of the guest and wherein the graphical image is a tattoo.
